(19) United States
(12) Patent Application Publication
(10) Pub. No.: US 2003/0200195 A1
(43) Pub. Date: Oct. 23, 2003

(54) Method and apparatus for providing access to information

(76) Inventor: Ronald P. Muhlenhaupt, Valley Forge, PA (US)

Correspondence Address: Reed Smith LLP, 2500 One Liberty Place, 1650 Market Street, Philadelphia, PA, 19103-7301, US

(21) Appl. No.: 10/419,389

(22) Filed: Apr. 21, 2003

Related U.S. Application Data
(63) Continuation of application No. 09/707,456, filed on Nov. 7, 2000.
Application No. 09/707,456 is a continuation-in-part of application No. 09/426,269, filed on Oct. 25, 1999, now abandoned.
Application No. 09/426,269 is a continuation-in-part of application No. 09/369,973, filed on Aug. 6, 1999, now abandoned.

(51) Int. Cl. G06F 7/00

(52) U.S. Cl. 707/1

(57) ABSTRACT

The invention is a method, process, system and apparatus for providing information through a single, easy to remember telephone number, or a single, easy to remember network address. In an effort to quickly and easily ascertain information about a particular product or service, the Customer accesses the single, easy to remember number or address, the system recognizes the single, easy to remember number or address which was used, and appropriately prompts the Customer for which company, person, entity, product or product line is relevant to the inquiry. Upon receiving the Customer's reply, the Customer then is automatically transferred to a final destination, such as a person, entity, company or product specific customer contact or response center, which provides the Customer with the desired information. The invention further comprises a method, process, system and apparatus for automatically connecting a signal, such as a telephone call or other communications signal, to a receiving device, which method, process, system and apparatus receives a keyword which correlates to a destination number, which destination number correlates to said receiving device; correlates said keyword to said destination number; and connecting said destination number to said receiving device.

### RELATED APPLICATIONS

This is a continuation of application Ser. No. 09/707,456, filed Nov. 7, 2000, which is a continuation-in-part (CIP) application of application Ser. No. 09/426,269 filed Oct. 25, 1999, which was a CIP of application Ser. No. 09/369,973 filed Aug. 6, 1999.

### BACKGROUND OF THE INVENTION

The explosion of the information age has provided consumers with access to information concerning virtually any topic imaginable, which prior to such explosion was difficult if not impossible to obtain. Presently, consumers may gain access to much of this information via telephone, and/or computer networks. Thus, consumers are constantly bombarded with telephone numbers, such as toll free “800”, “888”, and “877” numbers, as well as computer network addresses, such as Internet addresses. Although such telephone numbers and computer networks are helpful in accessing such information, it is difficult, if not impossible, for consumers to recall any particular number or network address, which provides the information desired. Currently, telephone directory assistance and computer search engines are of limited help because the consumer may often be required to know far more information than, for example, just a product, service or company name in order to access the desired information. Thus, there exists a need for a means to easily and quickly access such information through a single source and with a minimum of available information to the consumer.

For example, millions of dollars are invested every day in ineffective advertising relating to telephone numbers because the target audience cannot remember the telephone number, or if they remember the basic number, cannot remember the area code, or they can't remember how to spell the word used to create the mnemonic in the telephone number, whether or not it ties directly to the company name or product.

Most producers of consumers' goods and services and most manufacturers have information telephone lines and contact centers. Often companies have more than one telephone number to answer consumer inquiries, sometimes each product or product line has its own telephone number.

For instance, drug companies have and advertise telephone lines, often more than one, for emergency drug interactions and general questions. If a consumer of a drug is having an allergic reaction or is experiencing a negative side effect, the consumer may be under great stress and not be thinking clearly, finding it difficult to recall what telephone number to call for the particular relevant information. Time is of the essence in these situations and any delay (for example, one caused by being unable to recall the correct telephone number) may cause serious harm.

Many of the telephone companies have telephone numbers for directory assistance. Although a consumer can use these directory assistance numbers, there are several problems with these directory assistance numbers. First, directory assistance often requires you to know the city or area code for the number you desire. Second, the directory assistance may not have the information regarding which telephone number is appropriate for a particular product or product line. Third, connection (after making the initial inquiry) to the telephone number desired (“Destination Number”) requires often either requesting the connection and paying the telephone company an additional fee for automatic connection, or hanging up and dialing the Destination Number.

Another problem which is new to today's world is created by pervasive phone use, including cell phones and wireless technologies. A Customer of a cell phone may be engaged in other activities besides the phone conversation, such as, for example driving a car. Although many phones have features which allow the Customer to pre-program one or more particular persons' numbers, the Customer still has to scroll through the list of programmed numbers or remember the automatic dial number for that person. Even worse, Customers may be fumbling through address books and trying to dial the phone while driving a car or engaging in some other activity. The danger to the Customer and others (on the road and elsewhere) has been the cause of much concern.

The invention disclosed herein eliminates the need to recall many telephone numbers and what company, person or product is associated with each particular telephone number. Additionally, a Customer of the invention calls one telephone number and is ultimately connected to the desired information source (“Final Destination”) automatically.

### SUMMARY OF THE INVENTION

As will be demonstrated herein, this invention is directed to an apparatus and method for providing information to a Customer by accessing an information retrieval system via a Recalled Number; inputting Keywords into the information retrieval system as a query to obtain such information; automatically routing the query through the system to a Destination Number corresponding to a Final Destination, wherein the information may be accessed; and retrieving the information from the Final Destination. Although the system utilized herein may take any appropriate form, preferably, the system comprises a telephonic information retrieval system or computerized network.

In one embodiment of the invention, a client (“Client”) and a provider (“Provider”) enter into a service agreement (“Agreement”), wherein the Client lists a set of words or other designation which enables the system of this invention to process a Customer's request (“Keywords”), in, for example, English or any another language or languages, corresponding to words or other designations that a customer (“Customer”) would use to search for information on the Client, and Client lists one or more telephone numbers or other contact identifier (“Destination Number(s)”) or additional Keywords for each Keyword. The additional Keywords further narrow the type of information requested. The Destination Numbers provide information on that Keyword.

Further, in this embodiment the Provider provides an easy to remember telephone number(s) (“Recalled Number(s)”), which may or may not alphanumerically correspond to a word or phrase, and access to a system comprising one or more private branch exchange (PBX), preferably Nortel Meridian One 61C model in connection with one or more automatic speech recognition computer systems (“ASR”), preferably Liaison from Locus Dialogue Limited. The PBX includes but is not limited to one of a private branch exchange, a Key Service Unit and Centrex Custopak System. The ASR is a system with the ability to audibly detect human speech and parse that speech in order to generate a string of words, sounds or phonemes to represent what has been said. Natural Language Processing is the ability of the ASR to process the string of words, sounds or phonemes and understand the meaning.

One or more of the PBX is connected to a telephone network (“Telephone Network” or “Global Telephone Network”). Although the Telephone Network may comprise any suitable configuration, in a preferred embodiment, the Telephone Network provides dialed number identification service (“DNIS”) and automatic number identification (“ANI”) systems, the ANI identifies from where the Call came, and the DNIS identifies which Recalled Number the Customer used, and informs the PBX. The ANI allows the Provider to determine the geographical contact center if Client prefers distribution of inquiries geographically or will only serve inquiries from a specific geographical area.

Also, the Client and/or the Provider may advertise the Recalled Number as a telephone number to call for information. The Customer, looking for information, recalls and calls the Recalled Number. The Telephone Network takes the Call, generates information with the ANI/DNIS, and transfers this information to the PBX. The PBX and ASR are employed in connection with one or more Recalled Numbers. The PBX and ASR work together to prompt the Customer for a Keyword, preferably with a recorded human voice, and notify the Telephone Network of the Destination Number. The Telephone Network connects the Customer's Call ultimately to the Destination Number's site (“Final Destination”). Finally, the Customer receives the information requested from the Final Destination.

In another embodiment the Provider provides a Recalled Number or Recalled Numbers, which may or may not alphanumerically correspond to a word or phrase, and access to a system comprising one or more ASR's, which may or may not be a part of a Telephone Network. In this embodiment, the system does not include a PBX but further comprises a Telephone Network as described above.

Also, the Client and/or the Provider may advertise the Recalled Number as a telephone number to call for information. The Customer, looking for information, recalls and calls the Recalled Number. The Telephone Network takes the Call, generates information with the ANI/DNIS and transfers the information to the ASR. The ASR is employed in connection with one or more Recalled Numbers. The ASR works to prompt the Customer for a Keyword, preferably with a recorded human voice, and notify the Telephone Network of the Destination Number. The Telephone Network connects the Customer's Call ultimately to the Destination Number's site or Final Destination. Finally, the Customer receives the information requested from the Final Destination.

In another embodiment of the invention, the Recalled Number is an easy to remember computer network (“Computer Network”) address, the Destination Numbers are Computer Network addresses, and the Final Destination is a Computer Network site. The Computer Network in this embodiment includes, but is not limited, to the Internet, a corporate intranet, a government intranet, or on-line services. The Call is a request for information on the Computer Network and the Call is routed through the Computer Network via, for example, a computer or other information, storage, retrieval, and dissemination device. In a preferred embodiment, the invention iteratively one or more times, prompts the Customer for more specific Keywords and results in a connection to a discrete Final Destination, such as a website on the Internet.

In yet another embodiment of the invention, a Customer (“Customer”) and a Provider enter into a service agreement, wherein the Customer lists a set of words or other designations (“Keywords”) which enable the inventive system to process the Keywords in a request to correspond to particular phone number(s) for a person or entity. Additional Keywords may be required in order to particularly designate a single phone number, if the person or entity has more than one phone number. These phone numbers become Destination Numbers.

Further in this embodiment the Provider, through the system of this invention, may enable the Customer to program a Recalled Number into his or her phone, cellular phone or wireless device, so that the Recalled Number will be dialed automatically after receiving specific predetermined number(s) or code(s) (“Specific Codes”) from the phone, via, for example, the phone key pad or by similar means. Thus, the Customer may dial one or more Specific Codes, to reach the Recalled Number and then may or may not be prompted to provide one or more Keywords. Keywords are then entered by the Customer and received by the Provider via the system. The Keyword(s) are correlated to Destination Number(s) which Destination Number(s) are automatically dialed by the system. The Customer is then connected to the Destination Number by the system. Finally, after being connected to the Destination Number, the Customer is enabled by the system to engage in the phonecall with the recipient at the Destination Number.

In yet another embodiment, the present invention comprises a method for automatically connecting a signal, such as a telephone call or other communications signal, to a receiving device which method comprises the steps of: receiving a Keyword which correlates to a Destination Number, which Destination Number correlates to said receiving device; correlating said Keyword to said Destination Number; and connecting said Destination Number to said receiving device.

In still another embodiment the present invention comprises a system or apparatus for automatically connecting a signal, such as a telephone call or other communications signal, which system or apparatus comprises: a receiver which receives a Keyword correlating to a Destination Number; which Destination Number correlates to a receiving device; a comparitor which correlates said Keyword to said Destination Number; and a connection device which connects said Destination Number to said receiving device. The receiving device may comprise any appropriate receiving device including but not limited to a telephone, computer or other electronic device.

### BRIEF DESCRIPTION OF THE DRAWINGS

The invention will become more readily apparent from the following description of preferred embodiments thereof shown, by way of example only, in the accompanying drawings wherein:

FIG. 1 is a flowchart of an embodiment of the invention, which displays the steps in the inventive process.

FIG. 2 teaches the flow of information among the elements of one embodiment of the invention, such as the embodiment depicted in FIG. 1.

FIG. 3 is a flowchart of yet another embodiment of the invention, which details the steps of the inventive process.

FIG. 4 is a flowchart of another embodiment of the invention, which comprises a Computer Network.

FIG. 5 is a flowchart of yet another embodiment of the invention, which displays the steps of the inventive process.

FIG. 6 teaches the flow of information among the elements of one embodiment of the invention, such as the embodiment depicted in FIG. 5.

FIG. 7 is a flowchart of yet another embodiment of the invention, which details the steps of the inventive process.

FIG. 8 is a flowchart of yet another embodiment of the invention, which displays the steps in the inventive process.

FIG. 9 is a diagram of the system or apparatus which may carry out the process depicted in FIG. 8 or 10.

FIG. 10 is a flowchart of yet another embodiment of the invention, which displays the steps in the inventive process.

### DETAILED DESCRIPTION

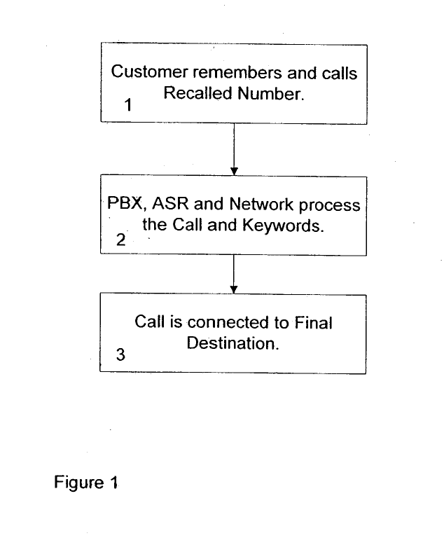

In a preferred embodiment of this invention shown in FIG. 1, the Client and/or the Provider advertise an easy to remember telephone number (“Recalled Number”). A Customer encounters the Recalled Number and at some time after being exposed to the Recalled Number, the Customer requires information relevant to one or more of the Client's company, product, and/or product line. In the first step of this embodiment, depicted as the number one (1) of FIG. 1 (the reference numbers in this written specification correspond to like numbers in the drawings) the Customer recalls the Recalled Number, calls the Recalled Number (the “Call”), and submits a Keyword or Keywords to the Telephone Network (1). The Call is received by the Telephone Network and the Telephone Network passes information regarding the DNIS and ANI to the PBX. The PBX communicates with the ASR. The ASR uses the DNIS information to determine which Recalled Number was called and thus, which prompt to use, as the ASR in turn communicates with the Customer, asking for a Keyword. A Recalled Number is associated with a particular prompt, such as, for example, in one embodiment the prompt may be “What information would you like today?”, and another Recalled Number may use the prompt for a different question, in another embodiment “Hello! How may I direct your call?”. Although the system of this invention may be designed to accommodate any word, the Keywords preferably comprise one or more company names, product names, product lines and other words.

In a preferred embodiment, the ASR transfers the prompt to the PBX, which in turn passes the prompt to the Telephone Network and ultimately to the Customer. The Customer enters a reply, which travels through the Telephone Network and the PBX, ultimately reaching the ASR. The next step in this embodiment is step two (2) where the ASR determines or associates the Destination Number with the Keyword entered into the system by the Customer, and provides the Destination Number to the PBX. Then the PBX communicates with the Telephone Network, the Telephone Network connects the Call with the Destination Number and the Call arrives at the Final Destination in step three (3) at which point the Customer may receive the desired information from the Final Destination.

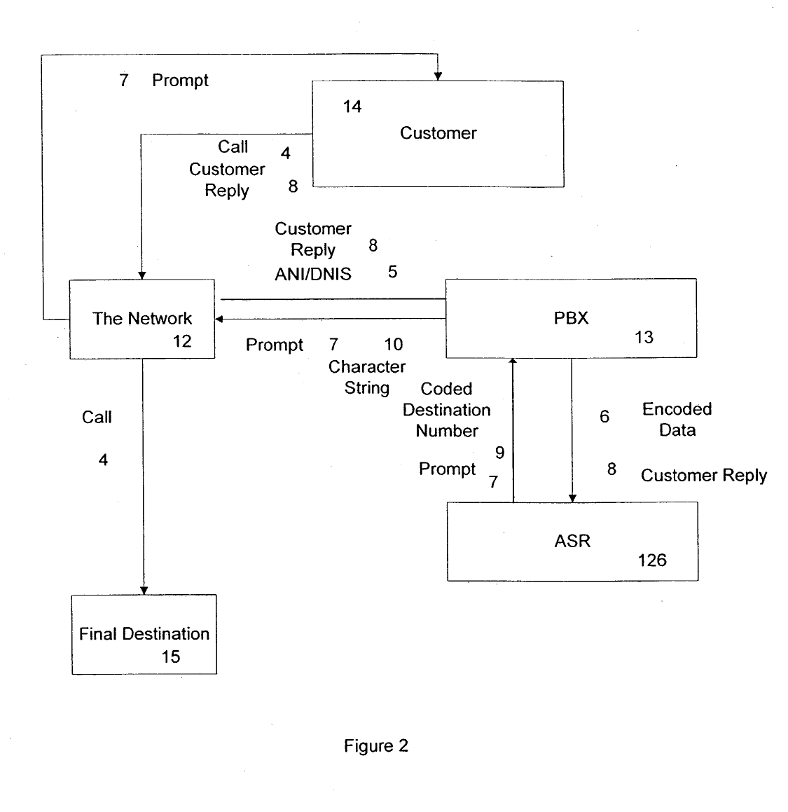

Referring now to FIG. 2, the flow of information between and among the elements in one embodiment of the invention, such as the embodiment of the invention depicted in FIG. 1, is demonstrated. In this embodiment, the Customer (14) recalls the Recalled Number and places a telephone call (“Call”) (4) to the Recalled Number. The Call is routed via communication lines, including but not limited to, telephone lines, and satellite transmissions, to the Telephone Network (12). The Telephone Network (12) has the ability to identify which Recalled Number was dialed (e.g. the DNIS) and from where the Call (4) came (e.g. the ANI). The Telephone Network (12) creates an ANI/DNIS (5) for the Call (4) and transfers the ANI/DNIS (5) to a PBX (13). The PBX (13) interprets the ANI/DNIS (5), generates Encoded Data (6) and transfers Encoded Data (6) to an automatic speech recognition system, ASR (126).

The ASR (126) interprets Encoded Data (6), and prompts the Customer (14) through the PBX (13) and the Telephone Network (12) for a Keyword (7). In a preferred embodiment, the Prompt (7) is a recording of a human voice. The Customer (14) speaks or enters in another manner a Reply (8), which Reply (8) may or may not be one or more Keywords, through the Telephone Network (12) and the PBX (13), which communicate the Reply (8) to the ASR (126).

The ASR (126) contains a processor that uses stored information to interpret the Reply (8) to determine if the Reply (8) includes Keywords, and to correlate the Keywords, if any, to specific telephone numbers (e.g. Destination Numbers) which connect to a site where information relating to the Keywords can be found (e.g. Final Destination (15)) or to an additional prompt for more specific information. The ASR (126) receives and interprets the Keyword or Keywords. Then, the ASR (126) produces a Coded Destination Number (9), which Coded Destination Number (9) includes the relevant Destination Number and transfers the Coded Destination Number (9) to the PBX (13).

The PBX (13) receives the Coded Destination Number (9), adds data to the Coded Destination Number (9), which becomes a Character String (10), said data and said Character String (10) are used to inform the Telephone Network (12) of the Destination Number for the Call (4), and transfers the Character String (10) to the Telephone Network (12). Once the Telephone Network (12) receives the Character String (10), the Telephone Network (12) interprets the Character String (10) and forwards the Call (4) to the Final Destination (15), at which point the Customer (14) may receive the desired information.

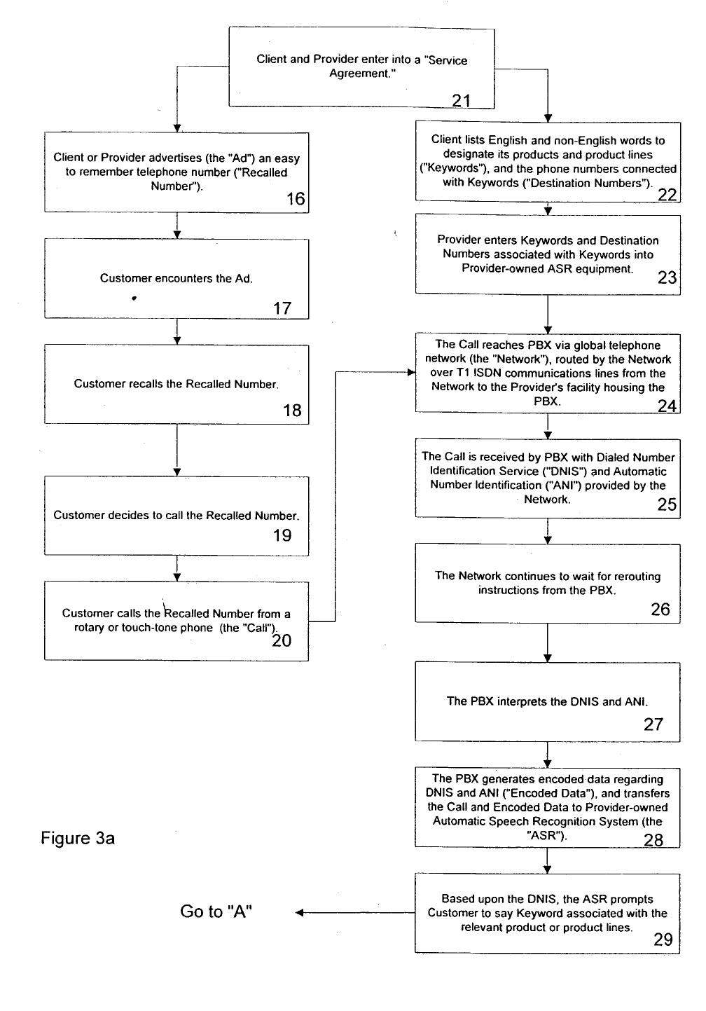

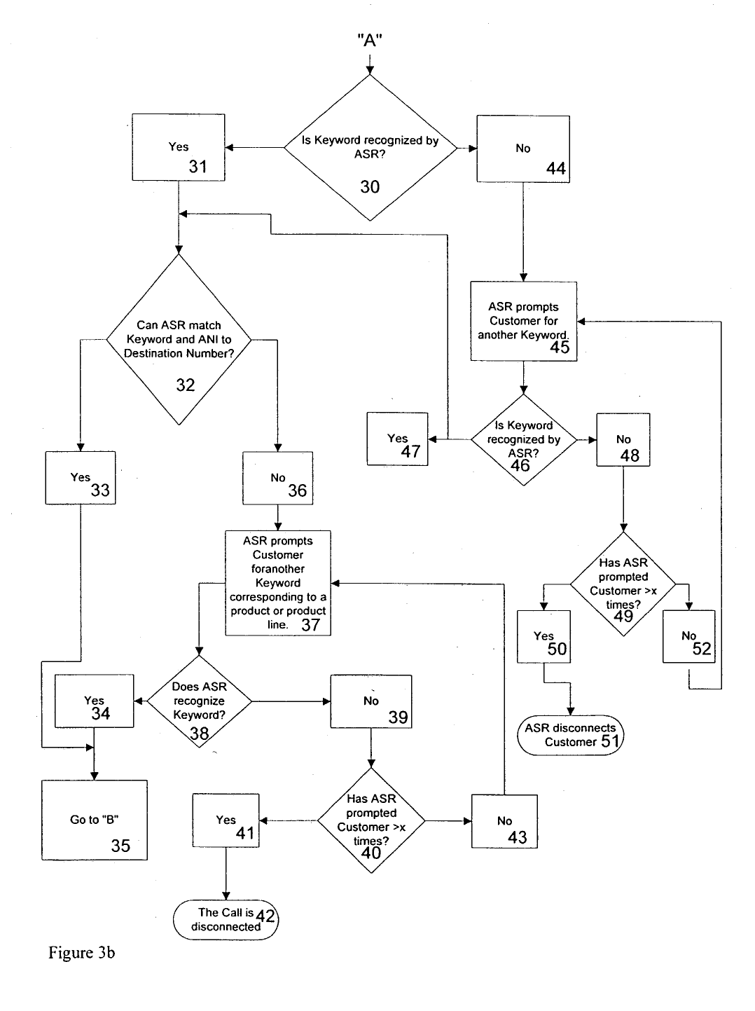

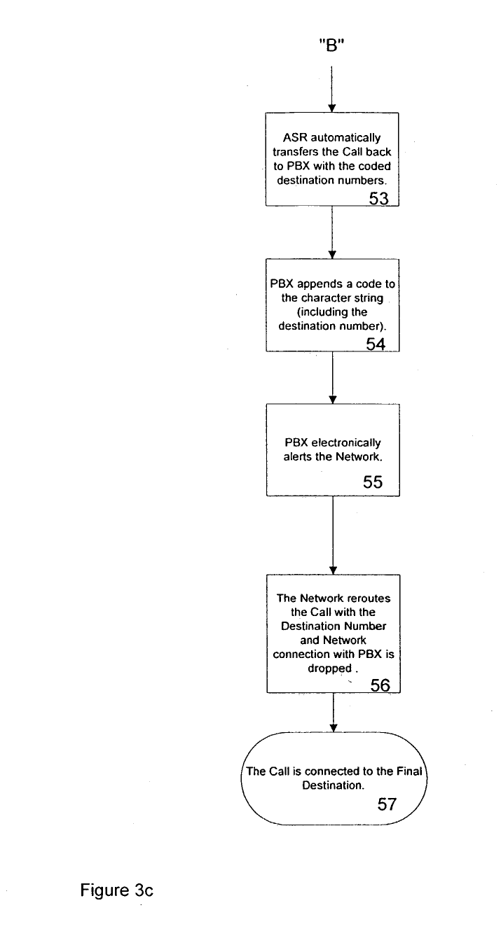

FIG. 3 demonstrates the steps of yet another preferred embodiment of the invention. Client and Provider agree to provide the ability to access information to Customers through, for example, a service agreement in Step (21). In this step, Provider agrees to, among other things, provide Client and Client's Customers with access to a Recalled Number. Client creates a list of English and/or non-English words which relate to one or more of a company name, product name, name of product line, and name associated with Client (“Keywords”) correlated with other Keywords and telephone numbers (“Destination Numbers”) for information associated with the Keywords in Step (22). Provider creates a database of Client's Keywords, Destination Numbers, and Prompts for use with one or more Recalled Numbers in the ASR (the “Database”) in Step (23).

Optionally, Client or Provider may advertise (the “Advertisement”) the Recalled Number in any media in Step (16). The Advertisement may or may not contain or be associated with one or more of the Keywords provided by Client.

In Step (17), a person or entity (“Customer”) becomes aware of the Recalled Number in some manner, including but not limited to encountering the advertisement, and word of mouth. In Step (18), Customer requires information from one or more Clients, and remembers the Recalled Number. Customer decides to call the Recalled Number in Step (19) and calls the Recalled Number in Step (20). Although a preferred embodiment utilizes rotary and touch-tone telephones for access to the system, the invention may be practiced with cellular, wireless or any other suitable communication system.

In Step (24), the Call proceeds through communication lines, most preferably T1 Integrated Services Digital Network (ISDN), or T3 telephones lines, or satellite, to the Telephone Network and through the Telephone Network to the PBX. As the Call passes through the Telephone Network, the Dialed Number Identification Service (“DNIS”) and Automatic Number Identification (“ANI”) is utilized in Step (25). The Telephone Network awaits instructions from the PBX in Step (26).

The PBX interprets the DNIS and ANI in Step (27), and generates encoded data regarding the DNIS and ANI, transfers the Call and Encoded Data to an Automatic Speech Recognition System (ASR), including but not limited to a computer system in Step (28). In Step (29), the ASR receives and processes the Encoded Data; the ASR notes which Recalled Number was dialed, from the DNIS information in the Encoded Data; and the ASR prompts the Customer through the PBX and the Telephone Network to enter, preferably vocally or by other suitable means, a word associated with the company, product, product line or any information inquiry (“Keyword”).

The ASR receives the Customer's reply through the Telephone Network and the PBX and checks the Database in the ASR to see if the Customer's reply is a Keyword in Step (30).

When the Customer's reply is a Keyword in Step (31), the ASR attempts to match the Keyword with a Destination Number in the Database in Step (32).

If there is a match, ASR generates a Coded Destination Number, comprising the Destination Number, and transfers the Coded Destination Number to the PBX in Step (53). The PBX generates a Character String, which preferably contains up to two alphanumeric characters and the Destination Number in Step (54). The Character String alerts the Telephone Network for taking back and transferring the Call. In Step (55), the Telephone Network is signaled, preferably electronically, by the PBX, and receives the Character String.

The Telephone Network sends the Call via the Destination Number to the Final Destination, and connection with the PBX is ended in Step (56). The Call is then connected to the Final Destination in Step (57).

If there is no match of the Keyword with a Destination Number in the Database in Step (36), the ASR prompts the Customer, preferably through the PBX and the Telephone Network, to enter, preferably vocally, a more specific Keyword associated with the Keyword previously entered in Step (37). The ASR receives the Customer's reply through the Telephone Network and the PBX and checks the Database to see if the Customer's reply is a Keyword in Step (38). If there is a match at Step (38), the process proceeds as described above in Step (53) of FIG. 3.

If there is no match of the Reply with a Keyword and/or a Destination Number at Step (38), the ASR counts the number of times which Customer has been prompted at Step (40). In setting the parameters in Step (40), the Provider has previously determined the Cut-off Number, which may be, for example, any integer between one and one hundred. In a preferred embodiment, the Cut-Off Number is programmed into the ASR. If the ASR notes that the number of Customer prompts is less than or equal to the Cut-Off Number in Step (40), the invention proceeds as previously described from Step (37) in FIG. 3. If the ASR notes that the number of Customer prompts is greater than the Cut-Off Number in Step (40), the ASR alerts the PBX to disconnect the Call at Step (42), preferably after notifying the Customer.

Returning to Step (30) in FIG. 3, if the Customer's reply is not a Keyword as in Step (44), the ASR prompts the Customer through the PBX and the Telephone Network to enter, preferably vocally, a word associated with the company, product, product line or any information inquiry (“Keyword”) at Step (45). The ASR receives the Customer's reply through the Telephone Network and the PBX and checks the Database to see if the Customer's reply is a Keyword in Step (46).

When the Customer's reply is a Keyword as in Step (47), the invention proceeds as previously described from Step (32) in FIG. 3.

If the Customer's reply is not a Keyword as in Step (48), the ASR counts the number of times which Customer has been prompted at Step (49). In setting the parameters in Step (40), Provider previously has set the Cut-off Number, which may be, for example, any integer between one and one hundred. If the number of Customer prompts is less than or equal to the Cut-Off Number as in Step (52), the invention proceeds as previously described from Step (45) in FIG. 3. If the number of Customer prompts is greater than the Cut-Off Number as in Step (50), the ASR disconnects the Call at Step (51), preferably after notifying the Customer.

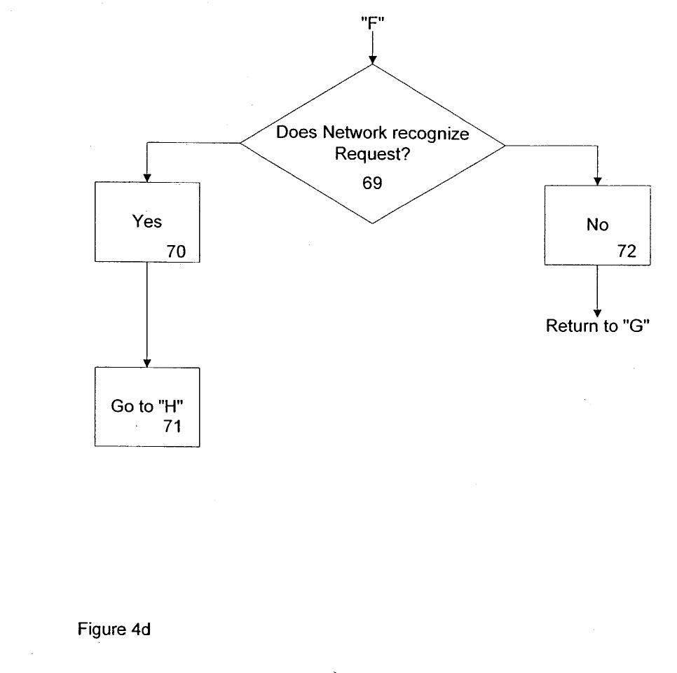

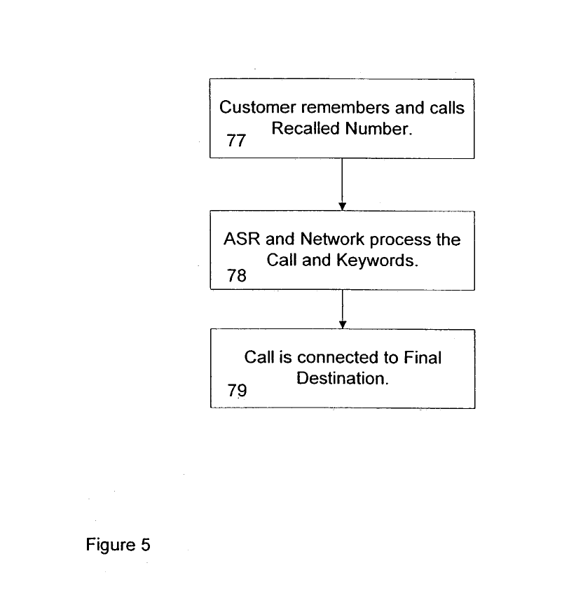

FIG. 5 depicts the steps of yet another preferred embodiment of this invention. In this embodiment, one or more of the Client and/or the Provider advertises a Recalled Number. A Customer encounters the Recalled Number and at some time after being exposed to the Recalled Number, the Customer requires information relevant to one or more of the Client's company, product, and/or product line. In the first step of this embodiment, depicted as the number seventy-seven (77) of FIG. 5 the Customer recalls the Recalled Number, calls the Recalled Number, and submits a Keyword or Keywords to the Telephone Network (77). In this next step of this embodiment depicted as number seventy-eight (78) in FIG. 5, the Call is received by the Telephone Network and the Telephone Network and ASR gather and generate information regarding the DNIS and ANI. The ASR uses the DNIS information to determine which Recalled Number was called and thus, which prompt to use, as the ASR in turn communicates with the Customer, asking for a Keyword. A Recalled Number is associated with a particular prompt, such as, for example, in one embodiment the prompt may be “What information would you like today?”, and another Recalled Number may use the prompt for a different question, in another embodiment “Hello! How may I direct your call?”. Although the system of this invention may be designed to accommodate any word, the Keywords preferably comprise one or more company names, product names, product lines and other words.

In the final step of this embodiment, depicted as number seventy nine (79), the Customer enters a reply, which travels through the Telephone Network and is interpreted by the ASR. The ASR determines the Destination Number and communicates with the Telephone Network, the Telephone Network connects the Call with the Destination Number and the Call arrives at the Final Destination at which point the Customer may receive the desired information from the Final Destination.

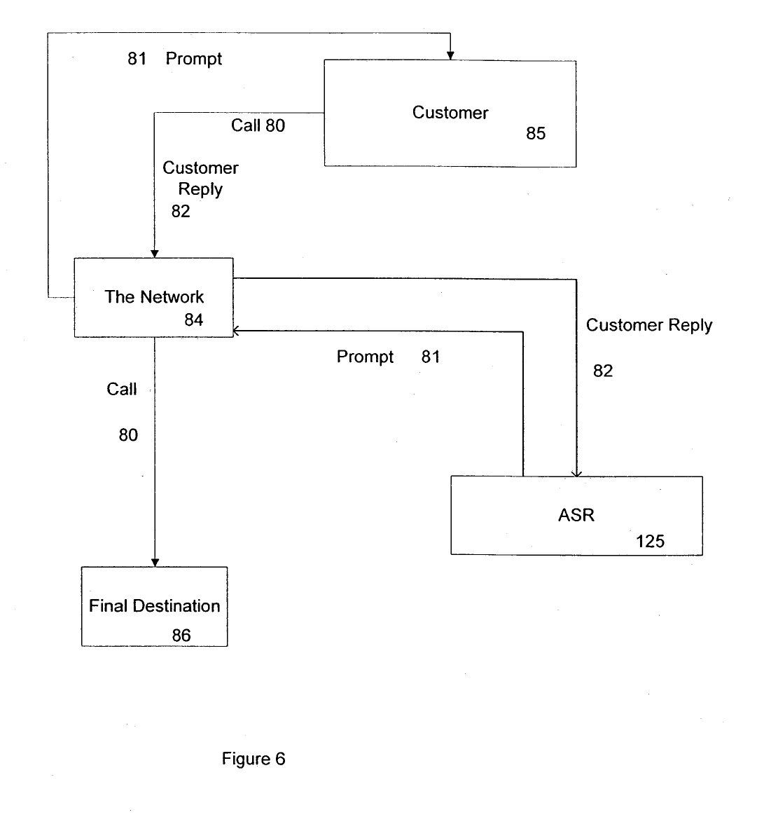

Referring now to FIG. 6, the flow of information between and among the elements in one embodiment of the invention, such as the embodiment of the invention depicted in FIG. 5, is demonstrated. In this embodiment, the Customer (85) recalls the Recalled Number and places a telephone call (“Call”) (80) to the Recalled Number. The Call (80) is routed via communication lines, including but not limited to, telephone lines, and satellite transmissions, to the Telephone Network (84). The Telephone Network (84) has the ability to identify which Recalled Number was dialed (e.g. the DNIS) and from where the Call (80) came (e.g. the ANI). The Network (84) creates an ANI/DNIS for the Call (80) and additionally uses an automatic speech recognition system, such as for example ASR (125).

The ASR (125) prompts the Customer (85) through the Telephone Network (84) for a Keyword. In a preferred embodiment, the Prompt (81) is a recording of a human voice. The Customer (85) speaks or enters in another manner a Reply (82), which Reply (82) may or may not be one or more Keywords, through the Telephone Network (84), which communicate the Reply (82) to the ASR (125).

The ASR (125) contains a processor that uses stored information to interpret the Reply (82) to determine if the Reply (82) includes Keywords, and to correlate the Keywords, if any, to specific telephone numbers (e.g. Destination Numbers) which connect to a site where information relating to the Keywords can be found (e.g. Final Destination (86)) or to an additional prompt for more specific information. The ASR (125) receives and interprets the Keyword or Keywords. Then, the ASR (125) produces the relevant Destination Number and informs the Telephone Network (84) of the Destination Number for the Call (80). Once the Telephone Network (84) receives the Destination Number, it forwards the Call (80) to the Final Destination (86), at which point the Customer (85) may receive the desired information.

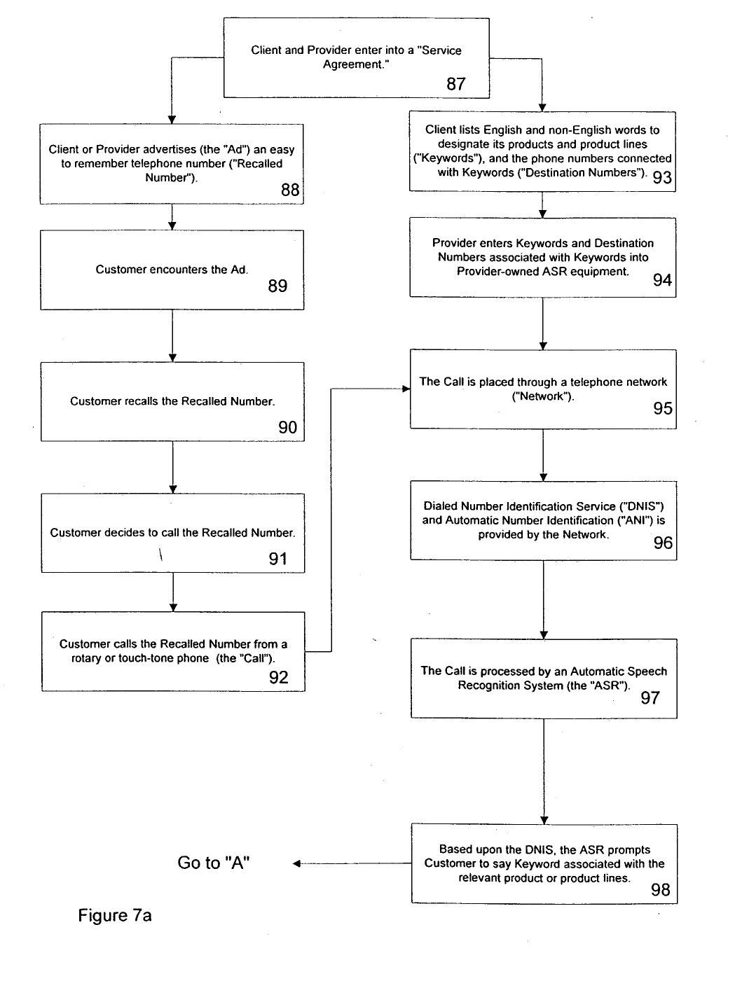

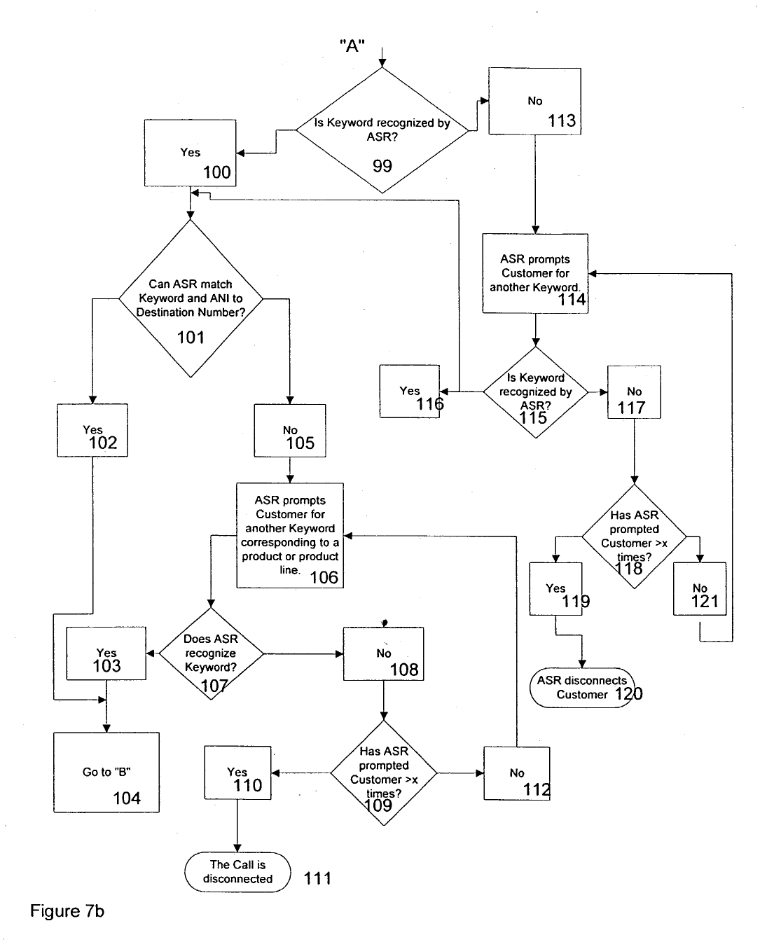

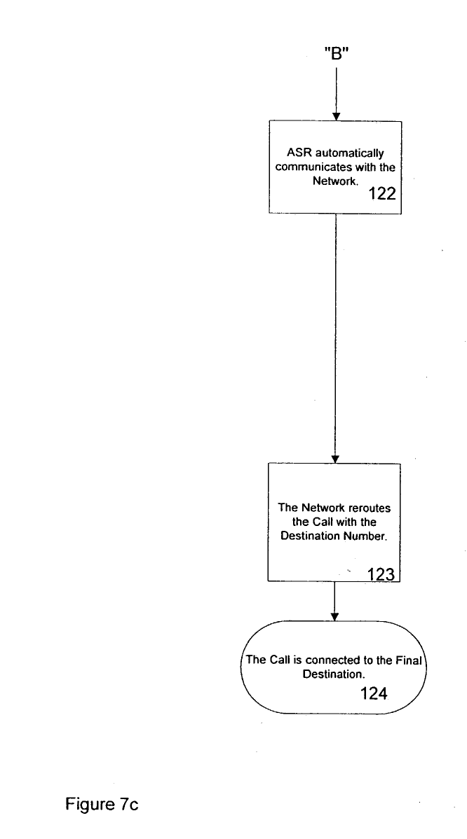

FIG. 7 demonstrates the steps of yet another preferred embodiment of the invention. Client and Provider agree to provide the ability to access information to Customers through, for example, a service agreement in Step (87). In this step, Provider agrees to, among other things, provide Client and Client's Customers with access to a Recalled Number. Client creates a list of Keywords correlated with other Keywords and Destination Numbers for information associated with the Keywords in Step (93). Provider creates a Database of Client's Keywords, Destination Numbers, and Prompts for use with one or more Recalled Numbers in the ASR in Step (94).

Optionally, Client and/or Provider may place an Advertisement of the Recalled Number in any media in Step (88). The Advertisement may or may not contain or be associated with one or more of the Keywords provided by Client.

In Step (89), a Customer becomes aware of the Recalled Number in some manner, including but not limited to encountering the advertisement, and word of mouth. In Step (90), Customer requires information from one or more Clients, and remembers the Recalled Number. Customer decides to call the Recalled Number in Step (91) and calls the Recalled Number in Step (92). Although a preferred embodiment utilizes rotary and touch-tone telephones for access to the system, the invention may be practiced with cellular, wireless or any other suitable communication system.

In Step (95), the Call proceeds through communication lines, most preferably ISDN, or T3 telephones lines, or satellite, to the Telephone Network. As the Call passes through the Telephone Network, the DNIS and the ANI are utilized in Step (96).

An ASR is employed to interpret the Customer's voice or other suitable prompt, in Step (97). In Step (98); the ASR notes which Recalled Number was dialed, from the DNIS information; and the ASR prompts the Customer through the Telephone Network to enter, preferably vocally or by other suitable means, a Keyword.

The ASR receives the Customer's reply through the Telephone Network and checks the Database in the ASR to see if the Customer's reply is a Keyword in Step (99).

When the Customer's reply is a Keyword in Step (101), the ASR attempts to match the Keyword with a Destination Number in the Database in Step (101).

If there is a match, ASR generates a Destination Number and communicates to the Telephone Network in Step (122). The Telephone Network sends the Call via the Destination Number to the Final Destination in Step (123). The Call is then connected to the Final Destination in Step (124).

If there is no match of the Keyword with a Destination Number in the Database in Step (105), the ASR prompts the Customer to enter, preferably vocally, a more specific Keyword associated with the Keyword previously entered in Step (106). The ASR receives the Customer's reply through the Telephone Network and checks the Database to see if the Customer's reply is a Keyword in Step (107). If there is a match at Step (107), the process proceeds as described above in Step (122) of FIG. 7.

If there is no match of the Reply with a Keyword and or a Destination Number at Step (107), the ASR counts the number of times which Customer has been prompted at Step (109). In setting the parameters in Step (109), the Provider has previously determined the Cut-off Number, which may be, for example, any integer between one and one hundred. In a preferred embodiment, the Cut-Off Number is programmed into the ASR. If the ASR notes that the number of Customer prompts is less than or equal to the Cut-Off Number in Step (109), the invention proceeds as previously described from Step (106) in FIG. 7. If the ASR notes that the number of Customer prompts is greater than the Cut-Off Number in Step (109), the Network disconnects the Call at Step (11), preferably after notifying the Customer.

Returning to Step (99) in FIG. 7, if the Customer's reply is not a Keyword as in Step (113), the ASR prompts the Customer through the Telephone Network to enter, preferably vocally, a word associated with the company, product, product line or any information inquiry (“Keyword”) at Step (114). The ASR receives the Customer's reply through the Telephone Network and checks the Database to see if the Customer's reply is a Keyword in Step (115).

When the Customer's reply is a Keyword as in Step (116), the invention proceeds as previously described from Step (101) in FIG. 7.

If the Customer's reply is not a Keyword as in Step (117), the ASR counts the number of times which Customer has been prompted at Step (118). In setting the parameters in Step (109), Provider previously has set the Cut-off Number, which may be, for example, any integer between one and one hundred. If the number of Customer prompts is less than or equal to the Cut-Off Number as in Step (121), the invention proceeds as previously described from Step (114) in FIG. 7. If the number of Customer prompts is greater than the Cut-Off Number as in Step (119), the ASR disconnects the Call at Step (120), preferably after notifying the Customer.

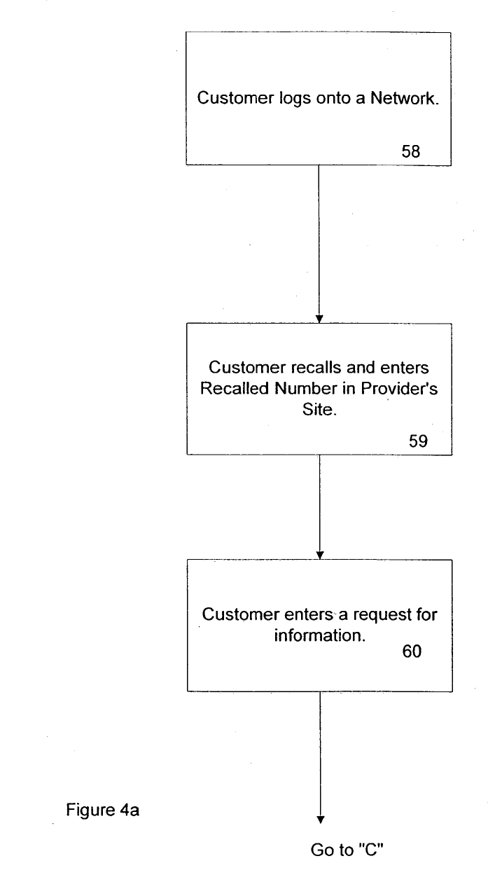

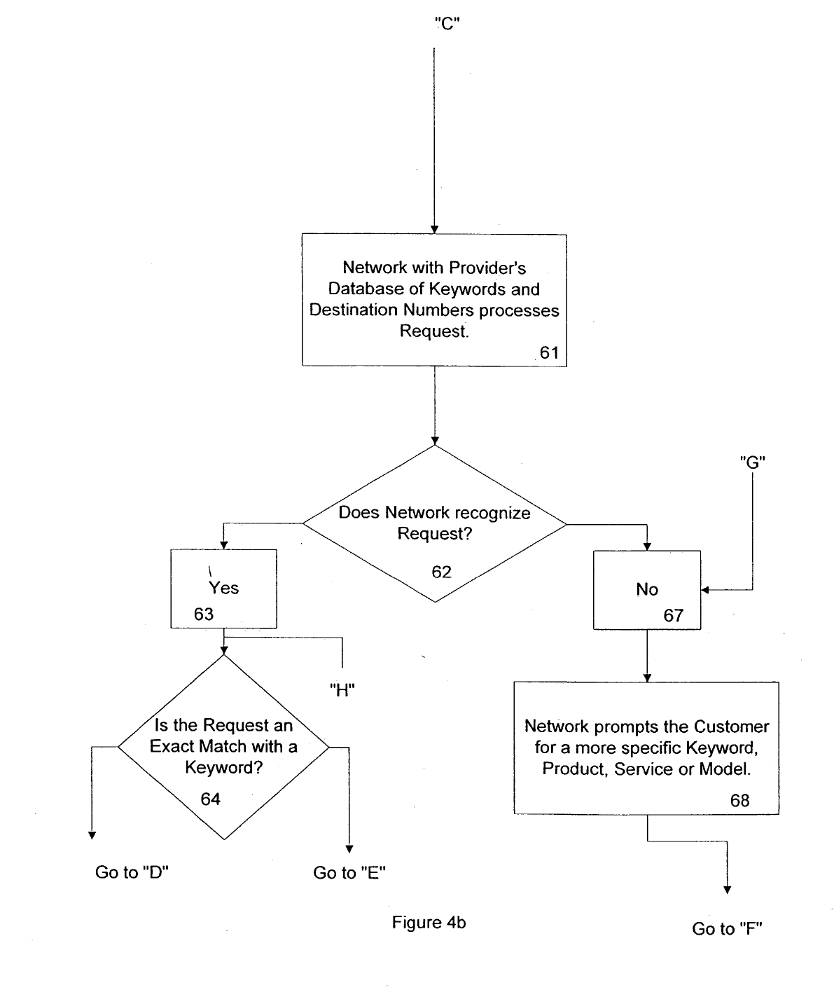

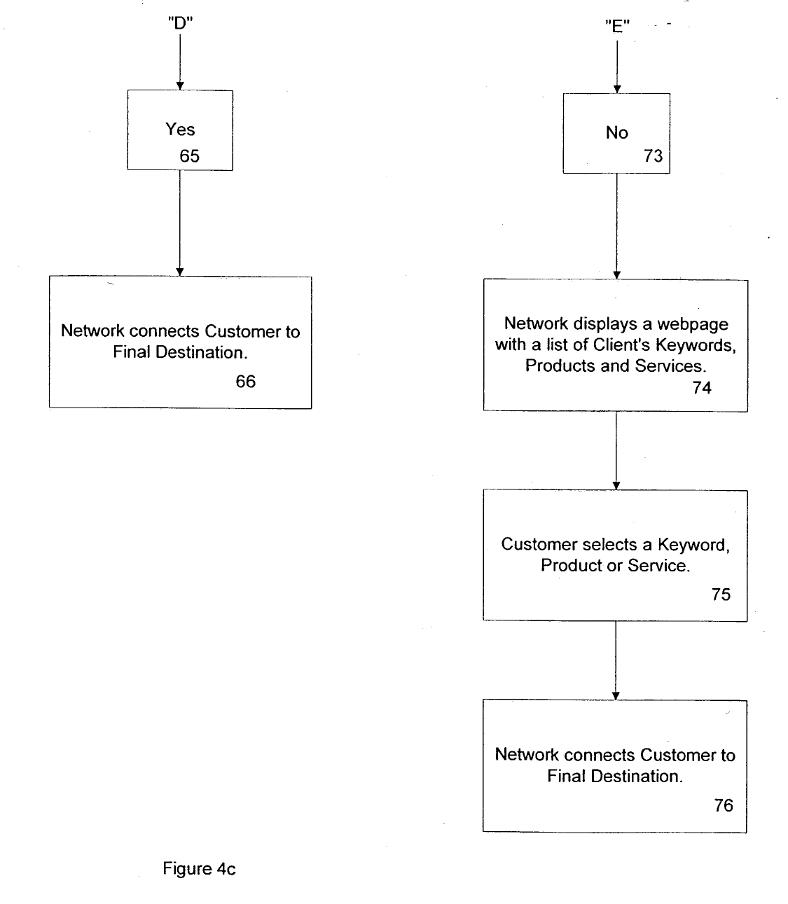

Turning now to FIG. 4, which depicts the steps of a separate preferred embodiment of the invention which employs a computer network to allow Client's Customers access to Client specific information contained, for example, on Client's Internet website, the Client and Provider may preferably enter into a service agreement. The Client identifies and supplies Provider with Keywords, and Destination Numbers, said Destination Numbers being Network Addresses. The Provider provides access to a Computer Network site with an easy to remember web address, referred to herein as the “Recalled Number.” Optionally, the Client and/or Provider may advertise the Recalled Number.

Referring now to FIG. 4, the Customer desiring information relating to the Client logs onto a Computer Network via a computer or other Network Access Device in Step (58) and recalls the Recalled Number and enters the Recalled Number of Provider's Network cite in Step (59). In Step (60), the Customer's Call is routed to a Computer Network Website associated with the Recalled Number; the Customer is prompted to enter one or more Keywords; and the Customer enters a Reply. In Step (61), the website provided by the Provider receives the Customer's Reply. The Computer Network assesses the Reply to determine if the Reply is recognized in Step (62).

When the Customer's Reply is recognized in Step (63), the Reply is analyzed to see if the Reply is an Exact Match with a Keyword in Step (64). If the Reply is a Keyword in Step (65), the Reply is associated with the Keyword and a Destination Number, and routes the Customer via the Destination Number to the desired website, which is the Final Destination in Step (66), at which point, Customer may retrieve Client specific information, such as Product or Product line specific information.

If the Reply is not an Exact Match with a Keyword as in Step (73), the Computer Network displays a webpage with a list of Client's Keywords in Step (74). The Customer selects a Keyword or Keywords from the webpage in Step (75) and the Reply is associated with the Keyword with a Destination Number to the desired website, which is the Final Destination in Step (76).

If the Customer's Reply is not recognized in Step (67), the Computer Network prompts the Customer for a more specific reply in Step (68). The Computer Network again evaluates the Reply to determine if the Reply is recognized in Step (69).

If the Computer Network recognizes the Reply in Step (70), the invention then proceeds as previously described from in Step (64) in FIG. 4.

If the Customer Reply is not recognized in Step (72), then the invention proceeds as previously described from in Step (67) in FIG. 4.

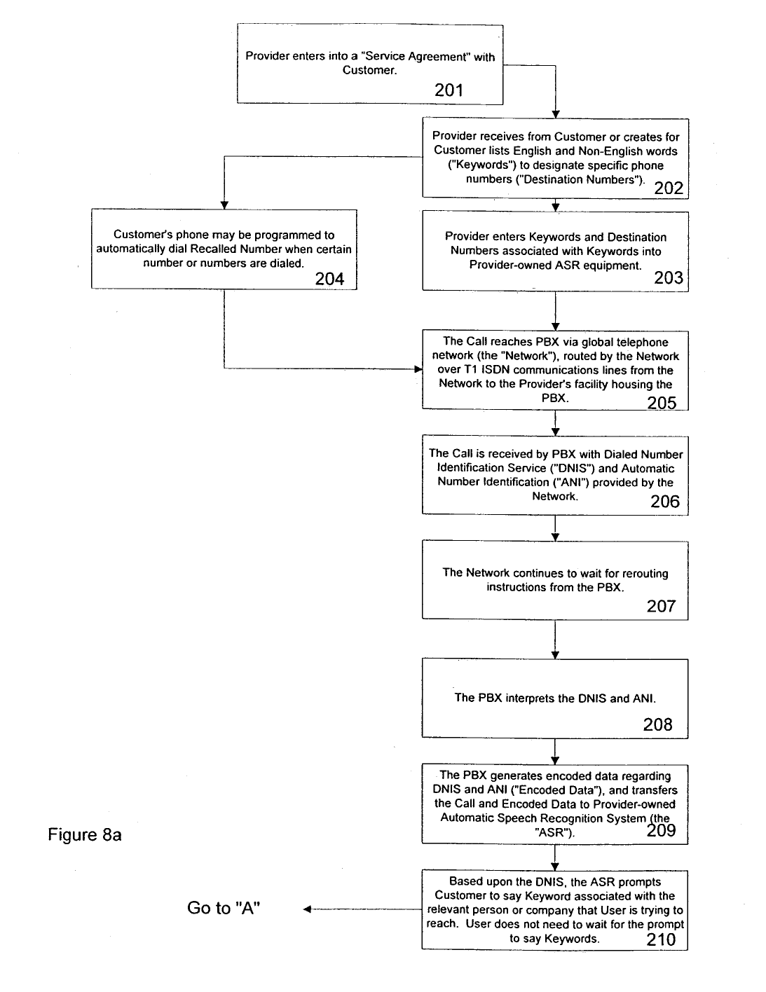

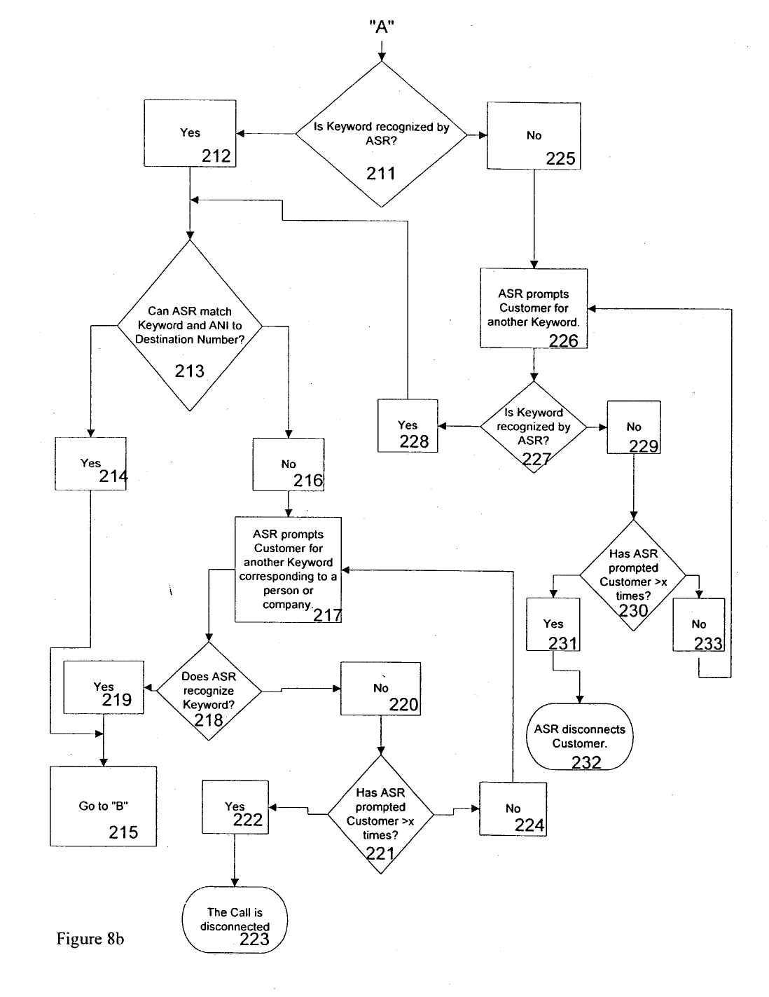

FIG. 8 demonstrates the steps of yet another embodiment of the invention. Provider enters into a service agreement or other arrangement with Customer in Step (201). In this step, Provider agrees to, among other things, provide the Customer with access to a Recalled Number, and the Customer's own designated phone numbers for persons or entities, which are correlated to a predetermined set of Keywords. For example, Keywords may comprise English and/or non-English words which relate to persons or entities which Keywords enable simplified access for calling particular phone numbers. The Keywords may also be correlated with other Keywords (if a person or entity has more than one phone number) and/or correlated with telephone numbers (“Destination Numbers”) in Step (202). For example, Customer may list “Work” as a Keyword and if “Work” has more than one phone number, “Voicemail” and “Receptionist” may be provided as Keywords correlated with “Work”, each of which would be correlated to particular phone number (i.e. the “Work” voicemail number and the “Work” receptionist number.) Provider creates a database of Customer's Keywords, and Destination Numbers for use with one or more Recalled Numbers in the ASR (the “Database”) in Step (203).

Additionally, the Customer's phone may also be programmed to automatically dial the Recalled Number with certain Specific Codes in step (204). Although one preferred embodiment of the invention utilizes touch-tone telephones for access to the system, the invention may be practiced with cellular, wireless or any other suitable communication system. In one embodiment a single button or other input device may be supplied on a cellular phone or other communication device such that when the button is actuated, the caller is automatically connected to the Recalled Number(s).

In Step (205), the Call proceeds through communication lines, most preferably through T1 Integrated Services Digital Network (ISDN), T3 telephones lines, or via satellite, to the Telephone Network and, then, through the Telephone Network to the PBX. As the Call passes through the Telephone Network, the Dialed Number Identification Service (“DNIS”) and Automatic Number Identification (“ANI”) is utilized in Step (206). The Telephone Network awaits instructions from the PBX in Step (207).

In Step 209, the PBX interprets the DNIS and ANI in Step (208), generates encoded data regarding the DNIS and ANI, and transfers the Call and Encoded Data to an Automatic Speech Recognition System (ASR) (which ASR may or may not be supplied or controlled by the Provider. In Step (210), the ASR receives and processes the Encoded Data; the ASR identifies and/or stores the Recalled Number dialed from the DNIS information in the Encoded Data; and, optionally, the ASR may prompt the Customer through the PBX and the Telephone Network to enter, preferably vocally or by other suitable means, a word associated with the person or entity. Alternatively, Keyword(s) may be entered into the system without prompting. For example, Customer may be prompted with “Hello! Who would you like to reach today?”, and can reply with “Work.” Further prompting may be required, such as “Which particular phone number?” and Customer may reply “Voicemail.”

Additionally in this embodiment, the DNIS may determine the phone number of the telephone from which the Customer is calling (“Origination Number”). If the Origination Number is recognized as one of Customer's personal numbers (including but not limited to his home, work and/or cellular phone number), then Customer may not be prompted to identify who he is. The system will then automatically associate Customer's Destination Numbers with any Keywords input by the Customer. If on the other hand, the Origination Number is not one of Customer's personal numbers, Customer will provide his Identifier (e.g. his name) with or without prompting. The Identifier is used to identify Customer's Database, and then Keywords are correlated as described below.

In Step (211) the ASR receives the Customer's reply through the Telephone Network and the PBX and checks the Database in the ASR to see if the Customer's reply is a Keyword.

When the Customer's reply is a Keyword in Step (212), the ASR attempts to match the Keyword with a Destination Number in the Database in Step (213).

If there is a match, ASR generates a Coded Destination Number, comprising the Destination Number, and transfers the Coded Destination Number to the PBX in Step (234). The PBX generates a Character String, which preferably contains up to two alphanumeric characters and the Destination Number in Step (235). The Character String alerts the Telephone Network for transferring the Call. In Step (236), the Telephone Network is signaled, preferably electronically, by the PBX, and receives the Character String.

In Step (237), the Telephone Network sends the Call via the Destination Number to the Final Destination, and connection with the PBX is optionally ended. The Call is then connected to the Final Destination in Step (238).

Returning to Step (213), if there is no match of the Keyword with a particular Destination Number (e.g. there is more than one Destination Number associated with this Keyword) in the Database in Step (216), the ASR may prompt the Customer, preferably through the PBX and the Telephone Network, to enter, preferably vocally, a more specific Keyword associated with the Keyword previously entered in Step (217). The ASR receives the Customer's reply through the Telephone Network and the PBX and checks the Database to see if the Customer's reply is a Keyword in Step (218). If there is a match at Step (218), the process proceeds as described above in Step (234) of FIG. 8.

If there is no match of the Reply with a Keyword and/or a Destination Number at Step (218), the ASR counts the number of times which Customer has been prompted at Step (221). In setting the parameters in Step (221), a Cut-off Number, which may be, for example, any integer between one and one hundred, has been predetermined and is recognized by the system. In a preferred embodiment, the Cut-Off Number is programmed into the ASR. If the ASR notes that the number of Customer prompts is less than or equal to the Cut-Off Number in Step (221), the invention proceeds as previously described from Step (217) in FIG. 8. If the ASR notes that the number of Customer prompts is greater than the Cut-Off Number in Step (221), the ASR alerts the PBX to disconnect the Call at Step (223), preferably after notifying the Customer.

Returning to Step (211) in FIG. 8, if the Customer's reply is not a Keyword in Step (225), the ASR may prompt the Customer through the PBX and the Telephone Network to enter, preferably vocally, a Keyword associated with the person or entity at Step (226). The ASR receives the Customer's reply through the Telephone Network and the PBX and checks the Database to see if the Customer's reply is a Keyword in Step (227).

When the Customer's reply is a Keyword in Step (228), the invention proceeds as previously described from Step (213) in FIG. 8.

If the Customer's reply is not a Keyword in Step (229), the ASR counts the number of times which Customer has been prompted at Step (230). In setting the parameters in Step (221), the system is set with a Cut-off Number, which may be, for example, any integer between one and one hundred. If the number of Customer prompts is less than or equal to the Cut-Off Number as in Step (233), the invention proceeds as previously described from Step (226) in FIG. 8. If the number of Customer prompts is greater than the Cut-Off Number as in Step (231), the ASR disconnects the Call at Step (232), preferably after notifying the Customer.

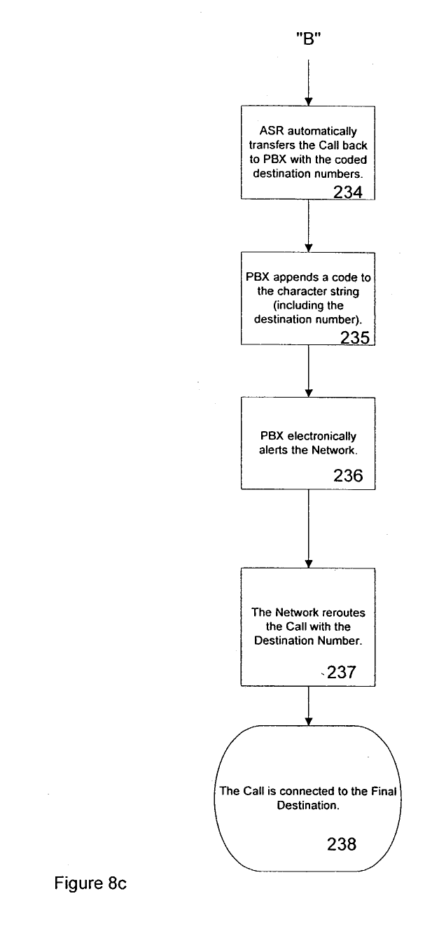

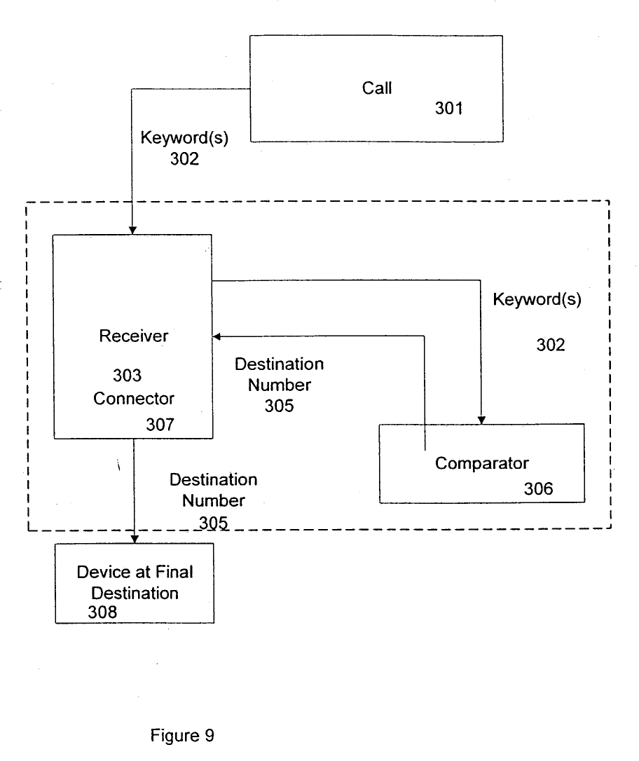

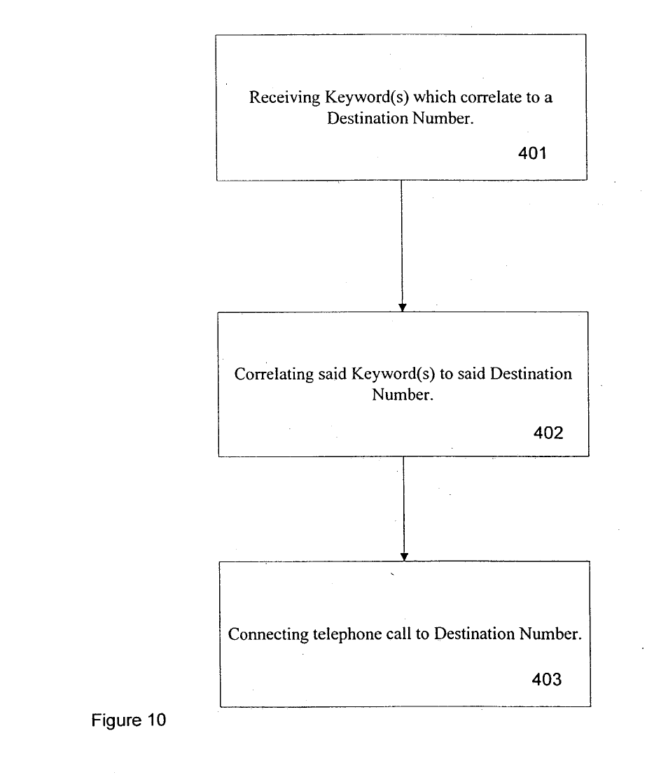

Referring now to FIG. 9, a schematic of the system or apparatus which may carry out the process of this invention, such as the embodiment of the invention depicted in FIG. 8 or 10, is demonstrated. In the embodiment depicted in FIG. 9, a telephone call to the Recalled Number (the “Call” (301)) is received by the system. The Call (301) is routed via communication lines, including but not limited to, telephone lines, and satellite transmissions, to the Telephone Network.

The Customer may be prompted by the system for a Keyword (302) which Keyword (302) corresponds to the Destination Number (309). In a preferred embodiment, a Receiver (303) receives from the Customer a verbal or other signal which corresponds to Keyword(s) (302).

The Receiver (303) receives the Keyword(s) (302) and transmits Keywords (302) to Comparitor (306). Comparitor (306) then correlates Keywords (302), to specific telephone numbers (e.g. Destination Numbers) (305) and transmits Destination Numbers (305) to Connector (307). Connector (307), which may or may not be one and the same as or part of the Receiver (303), connects the Call (301) having a Destination Number (309) to the Final Destination (308).

Yet another embodiment of the invention process of carrying out the invention is depicted in FIG. 10. The system receives the Keyword(s), which correlate to a Destination Number in step (401). The Keyword(s) are then correlated to the Destination Number in step (402), and the Call is connected to the Final Destination in step (403).

Although the invention has been described in detail for the purpose of illustration, it is to be understood that such detail is solely for that purpose and that variations can be made therein by those skilled in the art without departing from the spirit and scope of the invention.

What is claimed is:

1. A method for sending a first signal to a receiving device having a unique destination number comprising the steps of:
receiving a keyword;
automatically correlating said keyword to said destination number; and
sending said first signal to said receiving device.

2. The method of claim 1, wherein said receiving device is a telephone.

3. The method of claim 1, wherein said receiving device is a computer.

4. The method of claim 1, further comprising the step of receiving a second signal generated by or through a communication device, said second signal being received prior to the receipt of said keyword via a recalled number, which recalled number is accessed by actuating an input device which input device is an element of said communication device.

5. The method of claim 4, wherein said input device is a button.

6. The method of claim 4, wherein said actuation of said input device is a single keystroke.

7. A system for sending a first signal to a receiving device having a unique destination number, said system comprising:
a receiver which receives a keyword;
a correlator which automatically correlates said keyword to said destination number; and
a connection device which sends said first signal to said receiving device.

8. The system of claim 7, wherein said receiving device is a telephone.

9. The system of claim 7, wherein said receiving device is a computer.

10. The system of claim 7, wherein said receiver receives a second signal generated by or through a communication device, said signal being received prior to the receipt of said keyword via a recalled number, which recalled number is accessed by actuating an input device which input device is an element of said communication device.

11. The system of claim 10, wherein said input device is a button.

12. The system of claim 10, wherein said actuation of said input device is a single keystroke.

13. A method for providing information comprising:
providing access to an information retrieval system via a Recalled Number;
receiving a query comprising Keywords to obtain said information;
automatically routing said query through said system to a Destination Number corresponding to a Final Destination where said information may be accessed; and
retrieving said information from said Final Destination.

14. The method of claim 13, wherein said system is telephonic.

15. The method of claim 13, wherein said system is a computerized network.

16. An apparatus for providing information comprising:
a means for providing access to an information retrieval system via a Recalled Number;
a means for receiving a query comprising Keywords to obtain said information;
a means for automatically routing said query through said system to a Destination Number corresponding to a Final Destination where said information may be accessed; and
a means for retrieving said information from said Final Destination.

17. The apparatus of claim 16, wherein said system is telephonic.

18. The apparatus of claim 16, wherein said system is a computerized network.

19. An apparatus for providing information comprising:
a means for receiving a query via a telephone network with a receiver comprising a network website, said query entering a recalled number to request information by a customer;
a means for interpreting the query by a computer;
a means for generating one or more data based upon the request;
a means for correlating said recalled number and an associated prompt;
a means for asking the customer for a customer reply with said prompt;
a means for matching the customer reply with a keyword, a destination number, and a prompt for one or more said recalled numbers in a memory of said computer;
a means for generating the destination number;
a means for transferring the query with the destination number in the network; and
a means for connecting the query to an information site, said site being a website on the network having the requested information.

20. A method for providing information comprising:
receiving from a customer a query for information;
prompting said customer for a customer reply;
interpreting said customer reply;
generating a coded alphanumeric string based upon said customer reply, said string comprising an address of an information site, said site having the requested information available to the customer; and
connecting said customer to said site.

21. The method of claim 20, wherein said query comprises a telephone call, said call being placed to a recalled telephone number.

22. The method of claim 20, wherein said site comprises a destination for a telephone number.

23. The method of claim 20, wherein said site comprises a destination for a telephone number.

24. The method of claim 20, wherein said receiving step further comprises:
receiving said query via a telephone; and
processing said query via an automatic speech recognition system.

25. The method of claim 20, wherein said prompting comprises:
receiving the dialed number identification;
correlating said dialed number identification to the recalled number and an associated prompt;
asking the customer with the prompt for the customer reply; and
matching the customer reply with one or more of a keyword, a destination number, and a prompt for one or more said recalled numbers in a memory of said system.

26. The method of claim 20, wherein said generating comprises:
coding the destination number in the system;
transferring the coded destination number to the equipment; and
appending a second code to the coded destination number.

27. The method of claim 20, wherein said routing comprises:
alerting the network electronically; and
transferring the destination number to the network.

28. The method in claim 25 additionally comprises:
terminating the query, said terminating occurring after one or more attempts at said matching.

29. The method in claim 20 wherein said site comprises a website.

30. A method for providing information comprising:
receiving a query comprising a keyword via a telephone network;
transferring said query to an automatic speech recognition system;
correlating said keyword with a destination number at which said information is provided; and
transferring said query to said destination number.

31. A method for providing information comprising:
receiving a query via a network with a receiver comprising a network website, said query entering a recalled number to request information by a customer;
interpreting of the query by a computer;
generating one or more data based upon the request;
correlating said recalled number and an associated prompt,
asking the customer for a customer reply with said prompt;
matching the customer reply with a keyword, a destination number, and a prompt for one or more said recalled numbers in a memory of said computer,
generating the destination number,
transferring the query with the destination number in the network; and
connecting the query to an information site, said site being a website on the network having the requested information.

32. An apparatus for providing information comprising:
a telephone network with an automatic number identification system and a dialed number identification system;
a private branch exchange, said exchange communicatively coupled to said network; and
an automatic speech recognition system, said speech recognition system being communicatively coupled to said exchange.

33. An apparatus for providing information comprising:
an information processing computer, said computer communicatively coupled to at least one other customer computer to form a network; and
a network website, said website connected to client network websites located on said network; and said network website being accessible by said customer computer through said information processing computer and said information processing computer capable of connecting said customer computer to said client website.

34. A method for providing information comprising:
receiving a query via a telephone network, said query comprising a telephone call to a recalled number for information from a customer, the network capable of processing dialed number and an automatic number identification; and
identifying a dialed number from said telephone call;
generating one or more data based upon the identification of said dialed number;
correlating said dialed number identification to a recalled number and an associated prompt by an automatic speech recognition computer system;
prompting said the customer for a customer reply;
associating said customer reply with a keyword, a destination number, and a prompt for one or more said recalled numbers in a memory of said system;
providing the destination number to the network based upon said customer reply; and
connecting the query to an information site, said site being a destination for the destination number which disseminates said information.

35. An apparatus for providing information comprising:
a telephone network comprising an automatic number identification system and a dialed number identification system; and
an automatic speech recognition system, said recognition system being communicatively coupled to said network and capable of allowing access to said information.

36. The method of claim 13, wherein said information comprises one or more of the group consisting of opinions, positions, statistics, and messages of a political candidate.

37. The method of claim 13, wherein said information comprises one or more of the group consisting of company information, product information, product line information and service information.

38. The method of claim 13, wherein said information comprises information about one or more of the group consisting of medical professionals, business professionals, and legal professionals.

39. The apparatus of claim 16, wherein said information comprises one or more of the group consisting of opinions, positions, statistics, and messages of a political candidate.

40. The apparatus of claim 16, wherein said information comprises one or more of the group consisting of company information, product information, product line information and service information.

41. The apparatus of claim 16, wherein said information comprises information about one or more of the group consisting of medical professionals, business professionals, and legal professionals.

42. A method for connecting a phonecall comprising:
providing access to a phonecall connection system via a recalled number;
receiving input comprising keywords into said system as a query to connect said phonecall;
automatically routing said query through said system to a destination number corresponding to a final destination where said phonecall may be connected; and
connecting said phonecall to a device at said final destination.

43. The method of claim 42, wherein said system further comprises:
reading an Origination Number; and
relating an Origination Number to a customer's personal phone number and customer's database comprising said customer's keywords and destination numbers.

44. The method of claim 42, wherein said system further comprises:
reading an Origination Number, said Origination Number not a customer's personal phone number;
gathering a customer's identifier; and
relating said customer's identifier to a database of said customer's keywords and destination numbers.

45. The method of claim 42, wherein said system is telephonic.

46. The method of claim 42, wherein said system is a computerized network.

47. An apparatus for connecting a phonecall comprising:
a means for providing access to a phonecall connection system via a recalled number;
a means for receiving input comprising keywords into said system as a query to connect said phonecall;
a means for automatically routing said query through said system to a destination number corresponding to a final destination where said phonecall may be connected; and
a means for connecting said phonecall to a device at said final destination.

48. The apparatus of claim 47, wherein said system further comprises:
a means for reading an Origination Number; and
a means for relating an Origination Number to a customer's personal phone number and customer's database comprising said customer's keywords and destination numbers.

49. The apparatus of claim 47, wherein said system further comprises:
a means for reading an Origination Number, said Origination Number not a customer's personal phone number;
a means for gathering a customer's identifier; and
a means for relating said customer's identifier to a database of said customer's keywords and destination numbers.

50. The apparatus of claim 47, wherein said system is telephonic.

51. The apparatus of claim 47, wherein said system is a computerized network.
